(19) United States
(12) Patent Application Publication
(10) Pub. No.: US 2025/0334437 A1
(43) Pub. Date: Oct. 30, 2025

(54) METHOD FOR THE CONTACTLESS DETERMINATION OF CONDENSATE FORMATION

(71) Applicant: Endress+Hauser Flowtec AG, Reinach (CH)

(72) Inventors: Peppino Breda, Liestal (CH); Marc Werner, Grenzach-Wyhlen (DE); Benjamin Schwenter, Ettingen (CH)

(21) Appl. No.: 18/871,426

(22) PCT Filed: May 31, 2023
(86) PCT No.: PCT/EP2023/064516

§ 371 Date: Dec. 3, 2024

(30) Foreign Application Priority Data
Jun. 3, 2022 (DE) 10 2022 114 147.0

(51) Int. Cl. G01F 1/84; G01F 15/02; G01J 5/00; G01J 5/04; G01N 21/94; G01N 25/56

(52) U.S. Cl. CPC G01F 1/8436; G01F 15/024; G01J 5/0037; G01J 5/041; G01N 25/56; G01N 2021/945

(57) ABSTRACT

A method for the contactless determination of a condensate formation on a measuring tube surface of an, in particular metallic, measuring tube by means of an optical temperature sensor for the contactless detection of a temperature of the measuring tube of a modular Coriolis flowmeter includes identifying a condensate on the measuring tube surface when an output signal and/or a temporal change of the output signal of the optical temperature sensor is outside a tolerance range.

The invention relates to a method for the contactless determination of a condensate formation on a measuring tube surface of an, in particular metallic, measuring tube by means of an optical temperature sensor for the contactless detection of a temperature of the measuring tube, and to a modular Coriolis flowmeter for determining a process variable of a flowable medium.

Process measurement technology field devices with a vibration-type sensor and especially Coriolis flowmeters have been known for many years. The basic structure of such a measuring device is described in, for example, EP 1 807 681 A1, wherein reference is made in full to this publication with respect to the structure of a generic field device in the context of the present invention.

Typically, Coriolis flow meters have at least one or more vibratable measuring tubes which can be set into vibration by means of a vibration exciter. These vibrations are transmitted along the tube length and are influenced by the type of flowable medium located in the measuring tube and by its flow rate. At another point in the measuring tube, a vibration sensor or, in particular, two vibration sensors spaced apart from one another can record the varied vibrations in the form of a measurement signal or a plurality of measurement signals. An evaluation unit can then determine the mass throughflow, the viscosity, and/or the density of the medium from the measurement signal(s).

The measuring tubes are usually connected to the housing via a distributor piece. In this case, the three components mentioned are welded together. However, Coriolis flowmeters with interchangeable, disposable measuring tube arrangements based upon a modular design are also known. For example, in WO 2011/099989 A1, a method is thus taught for producing a monolithically formed measuring tube arrangement of a Coriolis flow meter with bent measuring tubes, wherein the measuring tube body of the respective measuring tubes is at first formed as a solid made of a polymer, and the channel for conducting the flowable medium is subsequently machined into said solid. WO 2011/099989 A1, like U.S. Pat. No. 10,209,113 B2, teaches a connecting body that is configured to receive and support a replaceable measuring tube module comprising thin-walled plastic tubes. The measuring tube module is fastened, via the connecting body, in a carrier device equipped with the necessary exciters and sensors.

Coriolis flowmeters are known from the prior art in which the temperature sensor is attached to the measuring tube by, for example, a soldered connection. However, such a solution is extremely disadvantageous for disposable applications, since in this case an electrical contact of the temperature sensor with a measuring circuit must be ensured when arranging the measuring tube module in the receptacle. In addition, this would mean that the temperature sensor would have to be disposed of after each use of the measuring tube module. Optical temperature sensors are known in principle. US 2017/0102257 A1 discloses the use of an optical temperature sensor in a conventional Coriolis flowmeter. The temperature sensor is located inside the housing and faces the measuring tube. However, such a solution is not suitable for disposable applications in which the measuring tube module is constantly replaced, since, when the measuring tube module is inserted into the measuring tube module receptacle, it may collide with the optical temperature sensor and thus damage both components. Furthermore, the disclosed solution is not cleanable and therefore not suitable for most biopharmaceutical applications.

Unlike conventional Coriolis flowmeters, the measuring tube modules in modular Coriolis flowmeters are not arranged so as to be hermetically sealed in a housing. This is due to the interchangeability of the measuring tubes. However, replacing the measuring tube modules and cleaning the carrier module means that humidity can enter the receptacle provided for the measuring tubes, which can condense on the measuring tubes of the measuring tube module. It is known from WO 2004/005089 A1 that, in addition to temperature sensors, dew point sensors are used which are in contact with the humidity present in the measuring chamber. However, the additional use of a dew point sensor in the receptacle of the modular Coriolis flowmeter would be extremely disadvantageous, since it would not ensure that the carrier module could be cleaned, and also no guaranteed conclusions can be drawn about the actual dew behavior of the moisture on the measuring tube.

The invention is based upon the object of remedying the problem and simplifying the method for determining the condensate formation.

The object is achieved by the method according to claim 1 and the modular Coriolis flowmeter according to claim 4.

The method according to the invention for the contactless determination of a condensate formation on a measuring tube surface of an, in particular metallic, measuring tube by means of an optical temperature sensor for the contactless detection of a temperature of the measuring tube, comprising the method steps of:
receiving a light beam, emitted from the measuring tube surface of the measuring tube, by means of the temperature sensor,
outputting an output signal correlating with the temperature of the measuring tube to an evaluation circuit,
identifying a condensate on the measuring tube surface if the output signal and/or a temporal change of the output signal is outside a tolerance range by means of the evaluation circuit,
optionally, issuing a warning that condensate has formed on the measuring tube.

In the context of the patent application, contactless determination is understood to mean a determination of the condensate formation on a measuring tube surface, in which the temperature sensor or components of the temperature sensor do not come into mechanical contact with the measuring tube surface and the condensate.

The temperature sensor comprises a sensor which is suitable for detecting the light beam and determining a light beam intensity. The optical temperature sensor can, for example, be an infrared temperature sensor. For this purpose, the temperature sensor can, for example, have a photodiode. Alternatively, the temperature sensor May comprise a light beam generating device which is designed to generate a light beam directed onto the surface, in particular the measuring tube surface, of the measuring tube. The optical temperature sensor is then designed to detect the light beam reflected at the surface, in particular the measuring tube surface.

The output signal essentially comprises the temperature of the measuring tube or a current signal correlating with the temperature of the measuring tube.

A contactless determination of a condensate formation is particularly advantageous in the case of vibrating measuring tubes. An advantageous application is found in a conventional Coriolis flowmeter and/or a modular Coriolis flowmeter for use in single-use applications for biopharmaceutical processes. In this case, the temperature sensor is oriented, relative to the measuring tube surface to be monitored, in such a way that the temperature measuring point is located on the measuring tube that vibrates during operation.

Coriolis flowmeters are also known in which the measuring tube has a measuring tube portion that, during operation, does not vibrate. Alternatively, the temperature sensor can accordingly be arranged such that the temperature measuring point is located on the portion of the measuring tube that does not vibrate during operation.

Advantageous embodiments of the invention are the subject matter of the dependent claims.

One embodiment comprises the method step of:
identifying a dissolution of the condensate when the output signal that was previously out of tolerance range returns to within the tolerance range.

One embodiment provides that the tolerance range have a first tolerance limit,
wherein the temperature sensor has a measuring range,
wherein the tolerance limit lies outside the measuring range.

Temperature sensors have a measuring range specified by the manufacturer, which indicates a temperature range in which the temperature sensor measures within its specifications. If measured values of the output signal and/or the temporal change of the output signal are outside the tolerance range and thus also outside the measuring range, the formation of a condensate is inferred.

The modular Coriolis flowmeter according to the invention for determining a process variable of a flowable medium comprises:
a measuring tube module,
wherein the measuring tube module comprises at least one measuring tube for guiding the medium,
wherein the measuring tube module has a primary exciter component,
wherein the measuring tube module has a primary sensor component;
a carrier module,
wherein the carrier module has a receptacle in which the measuring tube module can be detachably arranged,
wherein the carrier module has a secondary exciter component complementary to the primary exciter component,
wherein the carrier module has a secondary sensor component complementary to the primary sensor component,
a contactless temperature sensor,
wherein the contactless temperature sensor is arranged in/on the carrier module such that, when the measuring tube module is arranged in the carrier module, the contactless temperature sensor is directed at a measuring tube surface of the measuring tube and receives a light beam emitted from the measuring tube surface of the measuring tube,
wherein the modular Coriolis flowmeter is designed for carrying out the method according to any of the preceding claims.

A condensate on the measuring tube leads to an asymmetrical mass distribution of the measuring tube and thus to errors in the mass flow determination.

By using a contactless temperature sensor, arranging the temperature sensor in the electronics chamber, and separating the electronics chamber and the receptacle via an opening with protective glass, a solution for temperature measurements is obtained that is suitable for disposable applications and avoids damage when mounting the measuring tube modules.

A dew point sensor is used. The temperature sensor is arranged to be separated from the humidity in the receptacle and does not come into contact with it.

For carrying out the method according to the invention, the modular Coriolis flowmeter has electronic components—such as a processor, logical electronic components, etc.—which are suitable for carrying out the method steps of the method according to the invention themselves and/or in conjunction with the temperature sensor.

The alignment of the temperature sensor to the surface, in particular to the measuring tube surface of the metallic measuring tube, can also take place using or via one or more mirrors and/or prism lenses.

Advantageous embodiments of the invention are the subject matter of the dependent claims.

One embodiment provides that the temperature sensor be designed as an infrared sensor, and the light beam comprise infrared light.

By using an infrared sensor, the temperature of the medium to be conveyed remains unaffected, and contactless temperature measurements over short distances and in a light-sealed space are possible.

One embodiment provides that the at least one measuring tube be bent in a measuring tube portion,
wherein the measuring tube surface lies in the measuring tube portion.

One embodiment provides that the carrier module have a chamber for accommodating the temperature sensor,
wherein the chamber is separated from the receptacle by a carrier module wall,
wherein the temperature sensor is arranged in the chamber.

One embodiment provides that the temperature sensor in the chamber be sealed against the air in the receptacle.

One embodiment provides that an opening be arranged in the carrier module wall,
wherein a protective glass is arranged in the opening,
wherein the temperature sensor is arranged in the chamber and the measuring tube is arranged in the receptacle in such a way that the light beam passes through the opening, in particular through the protective glass which is at least partially transparent to the light beam, to the temperature sensor.

One embodiment provides that the protective glass have zinc sulfide at least in portions or be formed from zinc sulfide.

One embodiment provides that the protective glass have chalcogenides at least in portions, or be formed from chalcogenides.

The two materials mentioned for the protective glass are particularly suitable for the use of infrared sensors, as they are particularly transparent for radiation with a wavelength between 8 and 12 μm.

The invention is explained in greater detail with reference to the following figures, in which:

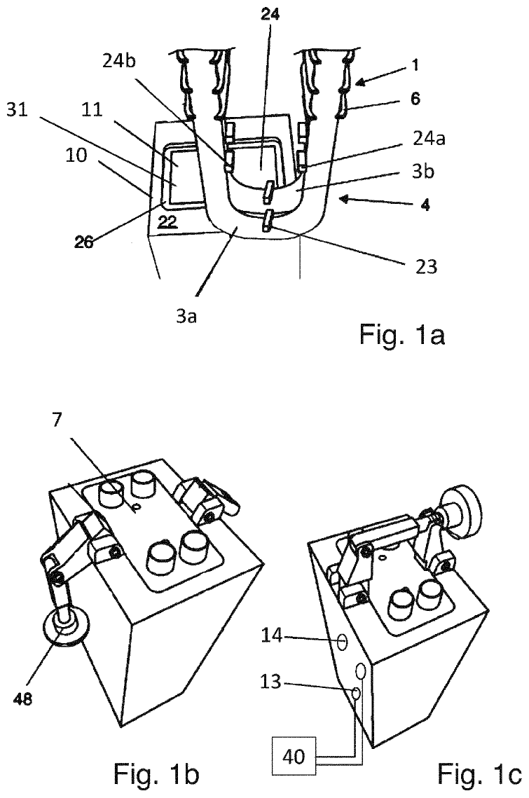

FIG. 1a is a perspectival view of an embodiment of the Coriolis flowmeter according to the invention, in which the measuring tube module is arranged next to the carrier module and its receptacle;

FIG. 1b is a perspectival view of an embodiment of the Coriolis flowmeter according to the invention, in which the measuring tube module is arranged in the receptacle;

FIG. 1c is a perspectival view of an embodiment of the Coriolis flowmeter according to the invention, in which the measuring tube module is fixed in the receptacle by a fastening device; and

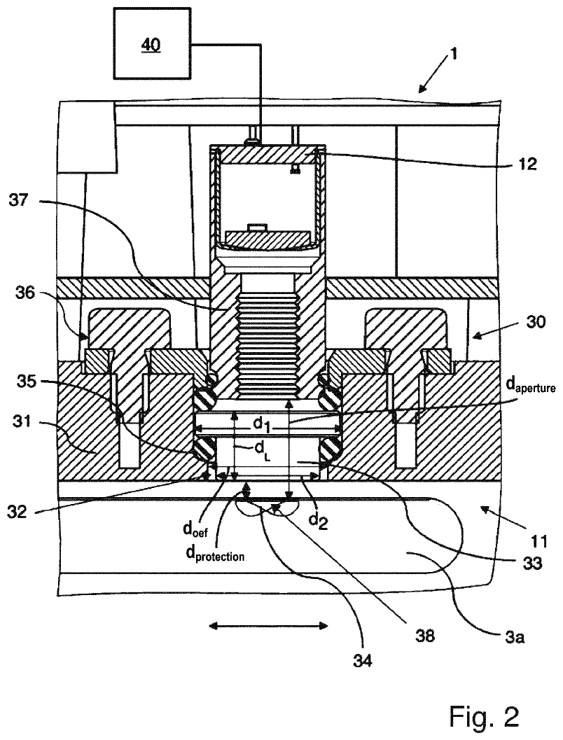

FIG. 2 is a detail view of a longitudinal section through an embodiment of the Coriolis flowmeter according to the invention.

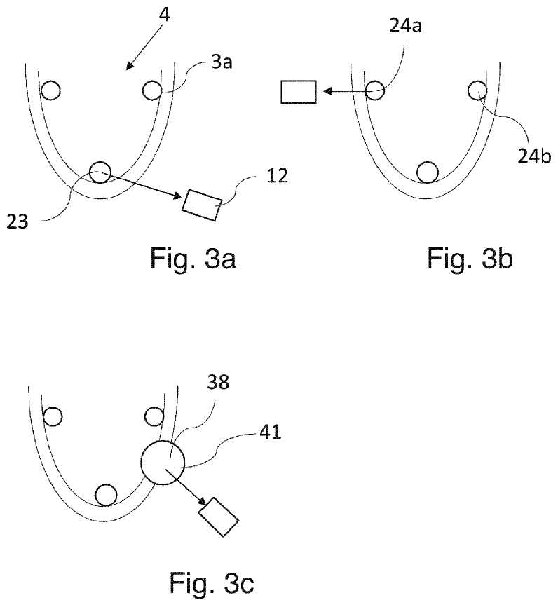

FIG. 3a-c show three embodiments of the modular Coriolis flowmeter according to the invention;

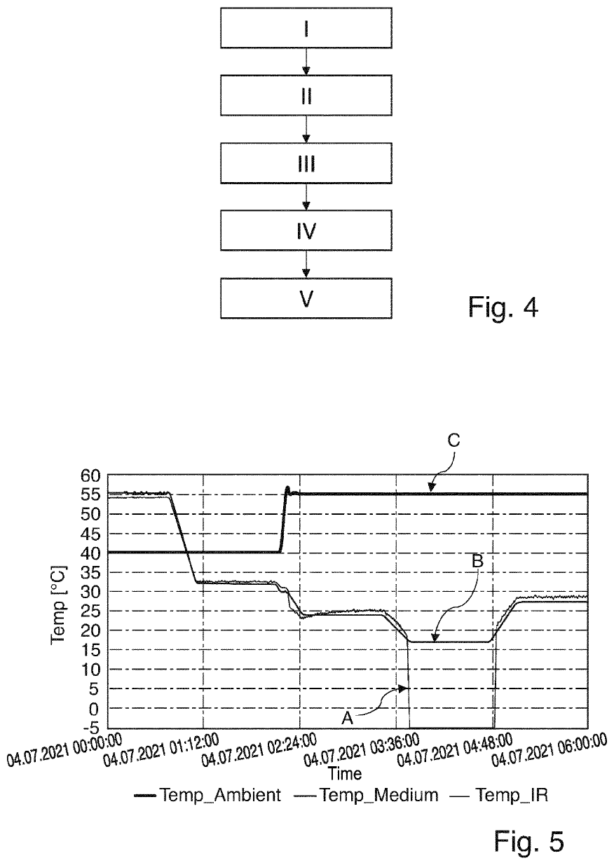

FIG. 4 shows a process chain for an embodiment of the method according to the invention for the contactless determination of a condensate formation; and

FIG. 5 is a graph in which the determined temperature of a flowing medium via the contactless temperature sensor and two reference sensors is plotted as a function of time.

An embodiment according to the invention is shown in FIGS. 1a to 1c. These show the stepwise assembly of the measuring tube module 4 in the receptacle 11 of the carrier module 10. FIG. 1a is a perspectival view of an embodiment of the Coriolis flowmeter 1 according to the invention, in which the measuring tube module 4 is arranged next to the carrier module 10 and its receptacle 11. The modular Coriolis flowmeter 1 for determining a process variable of a flowable medium comprises a measuring tube module 4 and a carrier module 10. The measuring tube module 4 comprises at least one measuring tube 3 for conducting the medium. The measuring tube 3 is preferably made of metal. However, it may additionally or alternatively comprise a plastic, a ceramic, and/or a glass. In the illustrated embodiment, the measuring tube module 4 comprises exactly two measuring tubes 3a, 3b. A primary exciter component 23 is arranged on the outer lateral surface of each of the measuring tubes 3a, 3b. The primary exciter component 23 comprises at least one permanent magnet. Furthermore, two primary sensor components 24a, 24b are attached to the outer lateral surfaces of the measuring tubes 3a, 3b. The primary sensor component 24a, 24b also comprises at least one permanent magnet. The respective inlet portions and the outlet portions of the two measuring tubes are connected to each other via a plate-shaped connecting body 7. This serves to attach a distributor piece (not shown) to the measuring tubes 3a, 3b and has the contact surface for the fastening device 48. Alternatively, the distributor piece can also be connected to the measuring tubes 3a, 3b without a connecting body 7. In this case, the measuring tube module 4 is fastened to the fastening device 48 via the distributor piece. According to the embodiment shown, the mechanical connection of the carrier module 10 with the measuring tubes 3a, 3b is made via the connecting body 7. In the final assembly state, the connecting body 7 rests on a contact surface 26 embedded in the carrier module body 22. Furthermore, mechanical couplers 6 are provided which connect the inlet portions or the outlet portions of the measuring tubes 3a, 3b to each other. The carrier module 10 comprises a receptacle 11 in which the measuring tube module 4 can be arranged with a detachable connection. The receptacle 11 is delimited by the carrier module wall 31 and, according to the embodiment shown, is essentially an opening in which, or a free volume in the carrier module 10 in which, the measuring tube module 4 can be arranged such that it can vibrate. The carrier module wall 31 is preferably made of metal. The measuring tube module 4 can be arranged laterally, perpendicular to its own longitudinal axis (not shown), or frontally in the direction of its own longitudinal axis, in the receptacle 11. Separated from the receptacle 11 by the carrier module wall 31 is a chamber 30 in which electronic components 40 for operating the modular Coriolis flowmeter 1 and for determining the process variable are arranged. The electronic components 40 may include connectors, cables, circuit boards, amplifiers, electronic circuits with resistors, capacitors, diodes, transistors and coils, digital and/or analog circuits, and/or a programmable microprocessor, i.e., a processor implemented as an integrated circuit. The electronic components 40 also include the operating circuit, control circuit, measuring circuit, evaluation circuit, and/or display circuit.

FIG. 1b shows a measuring tube module 4 arranged in the receptacle 11. In this case, the connecting body 7 rests on the contact surface 26. The measuring tubes 3a, 3b protrude into the receptacle 11 such that they can vibrate, without touching the carrier module wall 31 in the process. The connecting body 7 serves to form a connection with a connection body (not shown), in particular a distributor piece, with which the measuring tube module 4 can be connected to a process line. The measuring tube module 4 shown is not fixed.

FIG. 1c shows a Coriolis flowmeter 1 in which the measuring tube module 4 is fixed in the receptacle 11 by a fastening device 48 in such a way that it can be detached and replaced again by the operator. The measuring tube module 4 is mechanically detachably connected or connectable to the carrier module 10. After the measuring tube module 4 is fixed and thus properly arranged and set up, the secondary exciter component 13 and the secondary sensor component 14 are activated. In the arranged state of the measuring tube module 4, the secondary exciter component 13 and the primary exciter component 23, and correspondingly the secondary sensor component 14 and the primary sensor component 24a, 24b, interact magnetically. The secondary exciter component 13 is designed to cause the at least one measuring tube 3 to vibrate. For this purpose, the secondary exciter component 13 typically comprises a magnetic coil which is operated via an operating circuit. The operating circuit can be part of the electronic components 40. The coil generates a time-varying magnetic field, depending upon the operating signal with which it is operated. This causes a force on the primary exciter component 23, which causes at least one measuring tube 3 to vibrate. The vibration behavior of at least one measuring tube 3 is measured via the secondary sensor component 14. The temporally variable magnetic field of the primary sensor component 24a, 24b present locally at the secondary sensor component 14—which results from the vibration of the at least one measuring tube 3—generates an electrical measurement signal in the sensor component 14, which preferably also comprises a magnetic coil, which signal is included in the determination of the process variable. According to the embodiment shown, exactly two secondary exciter components 13 and four secondary sensor components 14 are provided. Alternatively, exactly one secondary exciter component 13 and exactly two secondary sensor components 14 may be sufficient for two measuring tubes 3a, 3b if these are arranged in the carrier module 10 in such a way that they are located between the two measuring tubes 3a, 3b, and thus also between the primary exciter components 23 and primary sensor components 24a, 24b, in the arranged state. The secondary exciter component 13 and the secondary sensor component 14 are arranged in/on the carrier module 10. For example, they can be arranged such that they are separated from the receptacle 11 by the carrier module wall 31. Alternatively, the carrier module wall 31 can have exciter openings corresponding to the number of secondary exciter components 13, in which openings the secondary exciter components 13 are arranged. The same applies to the secondary sensor component 14. The carrier module wall 31 can have sensor openings corresponding to the number of secondary sensor components 14, in which openings the secondary sensor components 14 are arranged.

FIG. 2 is a detail view of a longitudinal section through an embodiment of the Coriolis flowmeter 1 according to the invention. The carrier module wall 31 separates the receptacle 11 from the chamber 30. Electronic components 40 are arranged in the chamber 30 and are electrically connected to the secondary exciter component and/or the secondary sensor component (not shown). A measuring tube 3a of a measuring tube module is arranged in the receptacle 11. The carrier module wall 31 has a through-opening 32 which connects the receptacle 11 to the chamber 30. A protective glass 33 is arranged in this opening 32.

A contactless temperature sensor 12 is arranged in the chamber 30 for determining a temperature of the measuring tube 3a or of the medium guided in the measuring tube 3a. The temperature sensor 12 is oriented such that, when the measuring tube module or the measuring tube 3a is arranged in the carrier module 10, in particular in the receptacle 11, said sensor is directed onto a measuring tube surface 34 of the at least one measuring tube 3, in particular the measuring tube 3a, and receives a light beam, emitted from the measuring tube surface 34 of the at least one measuring tube 3, through the opening 32.

The temperature sensor 12 has an, in particular anodized, aperture 37 for blocking interference radiation, a lens, and an SMD IR sensor. In this case, the aperture 37 is preferably designed as a black radiator (e.g., made of anodized aluminum), such that it does not itself emit any radiation onto the SMD IR sensor. In the embodiment shown, the temperature sensor 12 is arranged on a circuit board. The aperture 37 has a minimum distance d_{aperture,min} to the measuring tube surface 34 of 1 mm, in particular of 2 mm and preferably of 4 mm. In addition, aperture 37 has a maximum distance d_{aperture,max} to the measuring tube surface 34 of 18 mm, in particular of 12 mm and preferably of 9 mm.

The protective glass 33 has zinc sulfide and/or chalcogenides, at least in portions. The protective glass is shaped, formed, and arranged in the opening in such a way that cleaning agent does not penetrate into the chamber 40 when cleaning the carrier module 10. For this purpose, the protective glass 33 has a first diameter d₁ in a first portion and a second diameter d₂ in a second portion. In this case, the first diameter d larger than the second diameter d₂, and the first diameter d₁ is larger than a smallest diameter d_{oef} of the opening 32. The protective glass 33 has a maximum extension d_{L,max} in the longitudinal direction of a maximum of 15 mm, in particular 10 mm and preferably 7 mm, and a minimum extension d_{L,min} of at least 0.5 mm, in particular 1 mm and preferably 3 mm. The receptacle 11 and the measuring tube module 4 are designed in such a way that a distance d_{protection} between measuring tube surface 34 and 8 protective glass 33 is smaller than 5 and larger than 0.5 mm, in particular smaller than 3 and larger than 0.7 mm and preferably smaller than 2 and larger than 1 mm. The dimensions are selected such that as little ambient radiation as possible penetrates through the opening into the temperature sensor 12 and that, if possible, only the radiation emitted by the measuring tube 3a is recorded by the temperature sensor 12.

In the second portion of the protective glass 33, a sealing means 35 for sealing the receptacle 11 relative to the receptacle 11—in the case shown, a sealing ring—is arranged on the protective glass 33, in particular in such a way that it is openly visible from the receptacle 11. This means that the requirement to ensure the product quality of medicinal products and active ingredients in accordance with current Good Manufacturing Practice (cGMP) and IP56, in force as of 2022, is met.

The carrier module 10 has a fastening device 36 for fixing the protective glass 33 in the opening 32. The fastening device is arranged in the chamber 30 and is designed or configured to press the protective glass 33 from the interior of the chamber 30 in the direction of the receptacle 11. In this case, the protective glass 33, in particular the first portion of the protective glass 33, is pressed against the sealing means 35. In the embodiment shown, the fastening device 36 comprises an annular disk which is connected to the carrier module wall 31 via screws. The aperture 37 extends through a central opening in the annular disk. The annular disk is in contact and interacts with a sealing ring which is arranged on a surface, facing the interior of the chamber 30, of the protective glass 33. Alternatively, the annular disk can be in direct contact with the protective glass 33. The annular disk has a collar which faces the protective glass 33 and which extends around the central opening of the annular disk. The annular disk is rotationally symmetrical in the embodiment shown.

Individual components of the electronic components 40 are also electrically connected to the temperature sensor 12—which can be designed as an infrared sensor. The infrared sensor is designed to detect infrared light and, depending upon this, to determine a temperature of the measuring tube 3a or a measured value correlating with the temperature of the measuring tube 3a. The temperature of the measuring tube 3a can be determined via the evaluation circuit. The temperature sensor 12 is suitable for determining the temperature of the measuring tube 3a in a contactless manner, i.e., without being in direct mechanical contact with the measuring tube 3a. Said sensor is also arranged in the chamber 30 and separated from the measuring tube 3a by a protective glass 33. In order to be able to determine a temperature of the measuring tube 3a, the temperature sensor 12 is oriented such that, when the measuring tube module is arranged in the carrier module, in particular in the receptacle 11, the temperature sensor 12 is directed onto a measuring tube surface 34 of the at least one measuring tube 3 and receives a light beam, emitted from the measuring tube surface 34 of the measuring tube 3, through the opening 32.

The receptacle 11 and the measuring tube module 4 are designed such that the receptacle 11 or the internal volume in which the at least one measuring tube is located is closed in a substantially light-sealed manner when the measuring tube module 4 is arranged.

The at least one measuring tube 3 or the illustrated measuring tube 3a has a temperature measuring point 38 in the form of a matting. The surface structuring of the temperature measuring point 38 differs from the structuring present on the remaining measuring tube surface. The temperature sensor 12 is oriented such that it is directed towards the temperature measuring point 38. The temperature measuring point 37 can be structured by means of a laser process, and/or a surface treatment by the action of blasting media, in particular sand. Alternatively, the temperature measuring point 37 can be formed by a film applied to the at least one measuring tube or the measuring tube 3a, which film can also have a structuring.

In the embodiment shown, the temperature sensor is directed at the measuring tube which vibrates during operation. Alternatively, the temperature sensor can also be aligned so that it is directed towards one of the mechanical couplers, towards a non-vibrating portion of the measuring tube, the connecting body 7, or the connection body or the distributor piece of the measuring tube module.

FIGS. 3a to 3c show a plurality of different embodiments of the measuring tube module 4, in which the temperature sensor 12 is directed at different surfaces of the measuring tube module 4 or determines the medium temperature based upon different radiating surfaces of the measuring tube module 4. In the embodiment of FIG. 3a, the contactless temperature sensor 12 is oriented such that it is directed towards the surface of the primary exciter component 23—in this case, the primary exciter component 23 is a permanent magnet attached to the measuring tube 3a—and receives a light beam emitted from the surface (see arrow).

In the embodiment of FIG. 3b, the contactless temperature sensor 12 is oriented such that it is directed towards the surface of the primary sensor component 24a—in this case, the primary sensor component 24a is a permanent magnet attached to the measuring tube 3a—and receives a light beam emitted from the surface (see arrow).

In the embodiment of FIG. 3c, the contactless temperature sensor 12 is oriented such that it is directed towards a surface of a component 41 attached to the measuring tube 3a—in this case, the attached component 41 is a black plastic component—and receives a light beam emitted by the surface (see arrow). The component 41 is designed such that a measurement signal resulting from the light emitted by the component 41 and received by the temperature sensor 12 is greater than a measurement signal that would result if the temperature sensor 12 were directed at a measuring tube surface of the measuring tube 3a. For this purpose, the component 41 has, for example, a cross-sectional area that is larger than a partial portion area of the measuring tube 3a that would contribute to the measurement signal at the temperature sensor 12.

FIG. 4 shows a process chain for an embodiment of the method according to the invention for the contactless detection of condensate formation.

In a first step (I), a light beam emitted from the measuring tube surface of the measuring tube is received by the temperature sensor. Alternatively, the light beam can be generated by a light beam generating device, directed by the device onto the measuring tube surface, and reflected there.

In a second step (II), an output signal correlating with the temperature of the measuring tube is output from the temperature sensor to an evaluation circuit of the—for example, modular—Coriolis flowmeter.

In a third step (III), condensate on the measuring tube surface is identified on the basis of the output signal or an evaluation signal created based upon the output signal. Condensate is present when the output signal and/or a temporal change in the output signal lies outside a previously defined tolerance range, or when the output signal and/or a temporal change in the output signal exceeds a specified tolerance limit. The identification is carried out by means of the evaluation circuit.

In an optional fourth step (IV), a warning is issued that condensate has formed on the measuring tube.

In a fifth step (V), which is also optional, a dissolution of the condensate on the measuring tube is identified when the output signal, which was previously outside the tolerance range, is again within the tolerance range.

FIG. 5 shows a graph of a series of tests in which the determined temperature of a flowing medium via the contactless temperature sensor (A) and two reference temperature sensors (B, C) is plotted as a function of time. For the method according to the invention and the modular Coriolis flowmeter, only one or exactly one optical temperature sensor (A) is provided. The reference temperature sensors (B, C) are part of the test series, but not of the method according to the invention. For the test series, the measuring tube 24 module according to the invention was arranged in a measuring chamber, and a flowable medium was passed through a measuring tube of the measuring tube module. The characteristic curve (A) describes the course of the temperature Temp_IR measured by the contactless temperature sensor—in this case, an infrared sensor. The characteristic curve (B) was recorded with a first reference temperature sensor that is in contact with the medium flowing through the measuring tube and measures the medium temperature Temp_Medium. The characteristic curve (C) was recorded with a second reference temperature sensor that interacts with and determines the ambient temperature Temp_Ambient of the measuring chamber. Firstly, it is clear from the graph that the temperature determined by the contactless temperature sensor corresponds well with the actual temperature of the medium. The slight deviation can be explained by the fact that, not the temperature of the medium directly, but, rather, only the temperature of the measuring tube or the measuring tube surface, is determined. The course of the characteristic curves A and B lie sufficiently well on top of each other even when the medium temperature changes in a stepwise manner. If the ambient temperature Temp_Ambient is also increased, a further reduction in the medium temperature and thus also in the measuring tube temperature will result in condensate formation at the measuring point to be monitored. This happens, in the curve shown, at a medium temperature of approx. 17° C. During this period, the contactless temperature sensor transmits incorrect measurement data in output signals that are outside the specified measuring range of the contactless temperature sensor and thus also outside the specified tolerance range. The condensate on the temperature measuring point causes reflections of the light beam, and only part of the light beam emitted from the measuring tube surface reaches the contactless temperature sensor.

After increasing the medium temperature above 17° C., the condensate dissolves, and the temperature signal determined from the output signal again corresponds to the actual medium temperature.

### LIST OF REFERENCE SIGNS

Modular Coriolis flowmeter 1
Measuring tube, 3a, 3b
Measuring tube module 4
Coupler 6
Connecting body 7
Carrier module 10
Receptacle 11
Temperature sensor 12
Carrier module body 22
Secondary exciter component 13
Secondary sensor component 14
Primary exciter component 23
Primary sensor component 24a, 24b
Contact surface 26
Chamber 30
Carrier module wall 31
Opening 32
Protective glass 33
Measuring tube surface 34
Sealing means 35
Fastening device 36 for fixing the protective glass
Aperture 37
Temperature measuring point 38
Electronic component 40
Component 41
Fastening device 48 for fixing the measuring tube module

1-9. (canceled)

10. A method for contactless determination of a condensate formation on a surface of a metallic measuring tube using an optical temperature sensor for the contactless detection of a temperature of the measuring tube, the method comprising:
receiving a light beam from the measuring tube surface of the measuring tube via the temperature sensor;
outputting an output signal correlating with the temperature of the measuring tube to an evaluation circuit;
identifying a condensate on the measuring tube surface when the output signal and/or a temporal change of the output signal is outside a tolerance range using the evaluation circuit.

11. The method according to claim 10, further comprising:
issuing a warning that condensate has formed on the measuring tube.

12. The method according to claim 10, further comprising:
identifying a dissolution of the condensate when the output signal, which was previously out of the tolerance range, returns to within the tolerance range.

13. The method according to claim 10,
wherein the tolerance range has a first tolerance limit,
wherein the temperature sensor has a measuring range, and
wherein the tolerance limit lies outside the measuring range.

14. A modular Coriolis flowmeter for determining a process variable of a flowable medium, the modular flowmeter comprising:
a measuring tube module, comprising:
at least one measuring tube configured to convey the medium;
a primary exciter component arranged on the at least one measuring tube; and
a primary sensor component arranged on the at least one measuring tube; and
a carrier module, comprising:
a receptacle in which the measuring tube module can be detachably disposed;
a secondary exciter component complementary to the primary exciter component;
a secondary sensor component complementary to the primary sensor component;
a contactless temperature sensor arranged in or on the carrier module such that, when the measuring tube module is disposed in the carrier module, the temperature sensor is directed at a surface of the measuring tube module and is arranged to receive light from the surface of the measuring tube module; and
an evaluation circuit configured to operate on a signal from the temperature sensor,
wherein the modular flowmeter is configured to perform the method according to claim 10.

15. The modular flowmeter according to claim 14, wherein the surface of the measuring tube module is a surface of the least one measuring tube.

16. The modular flowmeter according to claim 15, wherein the at least one measuring tube is bent in a measuring tube portion, and wherein the measuring tube surface lies in the measuring tube portion.

17. The modular flowmeter according to claim 14, wherein the temperature sensor is an infrared sensor, and the light comprises infrared light.

18. The modular flowmeter according to claim 14, wherein:
the carrier module includes a chamber configured to accommodate the temperature sensor;
the chamber is separated from the receptacle by a carrier module wall; and
the temperature sensor is arranged in the chamber.

19. The modular flowmeter according to claim 18, wherein the temperature sensor in the chamber is sealed against the atmosphere in the receptacle.

20. The modular flowmeter according to claim 19, wherein:
the carrier module wall includes an opening therein;
a protective glass, which is at least partially transparent to the light, is disposed in the opening; and
the temperature sensor is arranged in the chamber such that the light passes through the protective glass to the temperature sensor from the surface of the measuring tube module disposed in the receptacle.
